(19) United States
(12) Patent Application Publication
(10) Pub. No.: US 2004/0136559 A1
(43) Pub. Date: Jul. 15, 2004

(54) Voice coil and a speaker that uses the voice coil

(75) Inventor: Takashi Suzuki, Tendo-shi (JP)

Correspondence Address: YOUNG & THOMPSON, 745 SOUTH 23RD STREET 2ND FLOOR, ARLINGTON, VA, 22202

(73) Assignees: PIONEER CORPORATION, TOKYO-TO (JP); TOHOKU PIONEER CORPORATION, TENDO-SHI (JP)

(21) Appl. No.: 10/737,800

(22) Filed: Dec. 18, 2003

(30) Foreign Application Priority Data
Jan. 9, 2003 (JP) 2003-003226

(51) Int. Cl. H04R 1/00; H04R 11/02; H04R 9/06

(52) U.S. Cl. 381/400; 381/407

(57) ABSTRACT

It is one object for the present invention to improve current-carrying capacity of a wire and input characteristics. A speaker is provided with a wire unit, which is formed by combining a plurality of unit electric wires and the unit electric wires are electrically parallel with each other to form one voice coil; an insulation member for insulating the unit electric wires each other; a bobbin for being wound by the electric wires; a vibration plate for being vibrated by the bobbin; a magnet for surrounding the bobbin; a yoke for being substantially connected to the magnet; a plate for being substantially connected to the magnet; and a damper for being connected to the bobbin.

### BACKGROUND OF THE INVENTION

1. Field of the Invention

This invention relates to a voice coil that is used in acoustical equipment and to a speaker that uses the voice coil.

2. Description of the Related Art

The voice coil that is used in a speaker or the like is formed by winding a wire unit, which is a unit wire, around a bobbin. Normally, in order to improve the input characteristics, the sound quality and frequency characteristics, or the heat resistance of the speaker, the current-carrying capacity of the wire unit should be large.

However, when current flows in the wire unit of the voice coil, due to surface effects, the current only flows in the surface of the wire unit. Therefore, the current-carrying capacity is not increased very much even when the wire is thick. As a result, in order to practically improve the input characteristics, the sound quality and frequency characteristics, or the heat resistance of the speaker, the thickness of the wire unit must be greatly increased.

However, functionally it is desired that the voice coil be lightweight. Also, since the voice coil is located in the narrow space between the bobbin and the magnetic circuit, it is preferred that the entire thickness of the voice coil when wound around the bobbin (or in other words the cross-sectional thickness of the layered wire unit) be thin. It is preferred that the thickness of the wire unit be set by balancing these requirements. As a result, there is a limit to how thick the wire unit can be made, and there is an inconvenience in that it is difficult to increase the current-carrying capacity.

### SUMMARY OF THE INVENTION

Taking the above inconveniences into consideration, a first object of this invention to provide a voice coil and a speaker that uses it that is capable of increasing the current-carrying capacity of the wire unit while maintaining or without greatly increasing the overall diameter of the wire unit.

A second object of this invention is to provide a voice coil and a speaker that uses it that is capable of improving the input characteristics, the sound quality and frequency characteristics, or heat resistance while maintaining or without greatly increasing the overall diameter of the wire unit.

The above object of the present invention can be achieved by a voice coil of the present invention. The voice coil is provided with a wire unit, which is formed by combining a plurality of unit electric wires and the unit electric wires are electrically parallel with each other to form one voice coil; and an insulation member for insulating the unit electric wires each other.

In one aspect of the present invention can be achieved by the voice coil of the present invention. The voice coil of the present invention is, wherein the wire unit is formed by braiding the plurality of unit electric wires together.

In another aspect of the present invention can be achieved by the voice coil of the present invention. The voice coil of the present invention is, wherein the wire unit is formed by weaving the plurality of unit electric wires together.

In further aspect of the present invention can be achieved by the voice coil of the present invention. The voice coil of the present invention is, wherein the wire unit is formed by twisting the plurality of unit electric wires together.

In further aspect of the present invention can be achieved by the voice coil of the present invention. The voice coil of the present invention is, wherein the wire unit is formed by bundling the plurality of unit electric wires.

In further aspect of the present invention can be achieved by the voice coil of the present invention. The voice coil of the present invention is, the voice coil is further provided with a bonding material for bonding the plurality of unit electric wires to be integrated.

In further aspect of the present invention can be achieved by the voice coil of the present invention. The voice coil of the present invention is, wherein the wire unit is formed by integrating said plurality of unit electric wires using a bonding material.

In further aspect of the present invention can be achieved by the voice coil of the present invention. The voice coil of the present invention is, wherein the wire unit is Litz wire.

In further aspect of the present invention can be achieved by the voice coil of the present invention. The voice coil of the present invention is further provided with a bonding layer that is formed around the outside of the wire unit.

In further aspect of the present invention can be achieved by the voice coil of the present invention. The voice coil of the present invention is, wherein the wire unit is provided with two or more unit electric wires.

In further aspect of the present invention can be achieved by the voice coil of the present invention. The voice coil of the present invention is, wherein the plurality of unit electric wires each is provided with a conductive wire and an insulation layer that is formed around the outside of the conductive wire.

In further aspect of the present invention can be achieved by the voice coil of the present invention. The voice coil of the present invention is, wherein the plurality of unit electric wires are each covered by a bonding layer.

In further aspect of the present invention can be achieved by the voice coil of the present invention. The voice coil of the present invention is, wherein the plurality of unit electric wires are combined together such that the outer shape of a cross section taken across the diameter of the wire unit has a top-bottom symmetrical shape or left-right symmetrical shape.

According to the present invention, since a plurality of unit electric wires that are insulated from each other are combined into one wire, it is possible to increase the current-carrying capacity of the wire unit while maintaining or without greatly increasing the overall diameter of the wire unit. In other words, even though due to surface effects, the current flows only near the surface of each of the unit electric wires, since there are a plurality of unit electric wires in the wire unit, looking at the wire unit as a whole, the area through which current is flowing is large. Therefore, it is possible to increase the current-carrying capacity while maintaining the diameter d1 of the wire unit 12. Moreover, it is possible to decrease the diameter d1 of the wire unit 12 while maintaining the current-carrying capacity. When comparing the current-carrying capacity of a wire unit having a diameter and formed by combining a plurality of unit electric wires each having a comparatively small diameter into one wire, with that of a wire unit having a diameter and made from a single electric wire, the current-carrying capacity of the wire unit is larger.

The above object of the present invention can be achieved by a manufacturing method of voice coil bobbin of the present invention. The manufacturing method of the voice coil bobbin is provided with a covering process of covering unit electric wires with a bonding layer; a first winding process of winding unit electric wire around feed bobbins which is equal to the number of unit electric wires; a first feeding process of feeding unit electric wires from the feed bobbins; a inserting process of inserting unit electric wires into the bundling inlet, which positions these unit electric wires such that they come in contact with each other; a second feeding process of feeding the unit electric wires which are in contact with each other to the solvent-application unit; an applying process of applying the solvent-application unit solvent and bonding the unit electric wires together; a second winding process of winding bonded unit electric wires around the voice-coil bobbin by an auto-winding machine; and a heating process of heating the unit electric wires wound around the voice-coil bobbin together with the voice-coil bobbin.

According to the present invention, a plurality of insulated unit electric wires are combined together to more a wire unit, so it is possible to increase the current-carrying capacity of the wire unit while maintaining or without greatly increasing the overall diameter of the wire unit. Also, it is possible to reduce the diameter of the wire unit while maintaining the current-carrying capacity. Therefore, it is possible to improve the input characteristics, sound quality and frequency characteristics, or heat resistance of a speaker that uses the voice coil. Moreover, since it is possible to maintain or reduce the diameter of the wire unit while keeping sufficient current-carrying capacity, it is possible to maintain or reduce the weight of the voice coil. Also, it is possible to maintain or reduce the overall thickness of the coil (or in other words, thickness of a cross section of the layered wire unit) when the voice coil is wound around the bobbin.

The above object of the present invention can be achieved by a speaker of the present invention. The speaker is provided with a wire unit, which is formed by combining a plurality of unit electric wires and the unit electric wires are electrically parallel with each other to form one voice coil; an insulation member for insulating the unit electric wires each other; a bonding layer that is formed around the outside of the unit electric wire; a bobbin for being wound by the unit electric wires; a vibration plate for being vibrated by the bobbin; a magnet for surrounding the bobbin; a yoke for being substantially connected to the magnet; a plate for being substantially connected to the magnet; and a damper for being connected to the bobbin.

According to the present invention, since it is possible to increase the current-carrying capacity, it is possible to improve the input characteristics, sound quality and frequency characteristics, or heat resistance of a speaker that uses the voice coil. Also, since it is possible to maintain or decrease the diameter of the wire unit while keeping sufficient current-carrying capacity, it is possible to maintain or reduce the weight of the voice coil. Moreover, it is possible to maintain or reduce the overall thickness of the voice coil when the wire unit is wound around the bobbin.

### BRIEF DESCRIPTION OF THE DRAWINGS

FIG. 1 is a side view showing the voice coil of a first embodiment of this invention.

FIG. 2 is an enlarged cross-sectional view of a cross section cut across the diameter of the voice coil shown in FIG. 1.

FIG. 3 is a side view of a voice coil of a second embodiment of the invention.

FIG. 4 is an enlarged cross-sectional view of a cross section cut across the diameter of the voice coil shown in FIG. 3.

FIG. 5 is a side view of a voice coil of a third embodiment of the invention.

FIG. 6 is an enlarged cross-sectional view of a cross section cut across the diameter of a voice coil of a fourth embodiment of the invention.

FIG. 7 is an enlarged cross-sectional view of a cross section cut across the diameter of a voice coil of a fifth embodiment of the invention.

FIG. 8 is a vertical cross-sectional view showing a speaker that contains the voice coil of this invention.

FIG. 9 is an enlarged cross-sectional view of the voice coil and voice bobbin contained in the speaker shown in FIG. 8.

FIG. 10 is an enlarged cross-sectional view of the wire unit of the voice coil shown in FIG. 9.

FIG. 11 is a cross-sectional view of the unit electrical wire that is supplied as raw material for the voice coil or wire unit before the voice coil or wire unit of the embodiments of this invention is manufactured.

FIG. 12 is a drawing explaining an example of the method of manufacturing the voice coil of the embodiments of this invention.

### DESCRIPTION OF THE PREFERRED EMBODIMENTS

The preferred embodiments of the invention will be explained below based on the drawings.

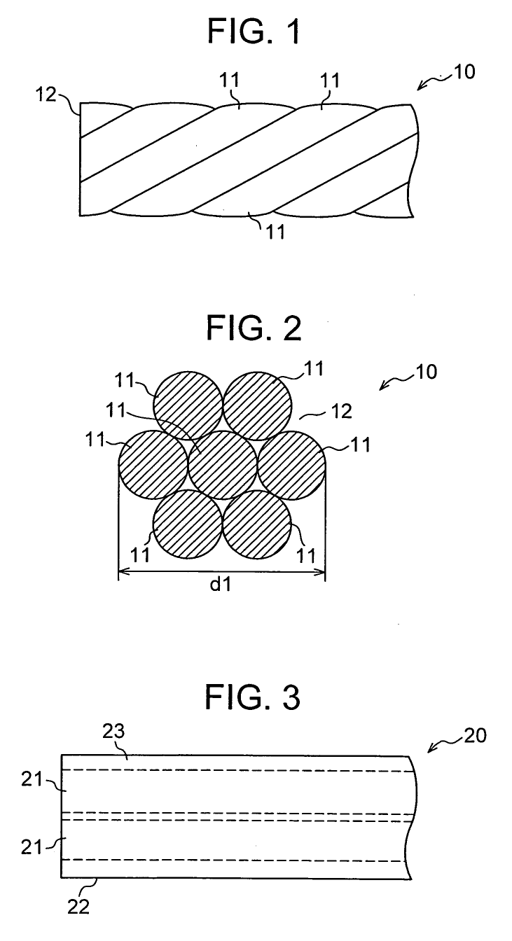

FIG. 1 is a side view showing the voice coil of a first embodiment of the invention. FIG. 2 is an enlarged cross-sectional view of a cross section taken across the diameter of the voice coil shown in FIG. 1. Both FIG. 1 and FIG. 2 show in detail the construction elements of the voice coil of this first embodiment of the invention only in order to explain the technical concept of the embodiment, however, the invention is not limited to the shape, size, position and connecting relationship of the construction elements. This is also true for FIG. 3 to FIG. 7 that are used to explain the other embodiments of the invention.

As shown in FIG. 1 and FIG. 2, the voice coil of this first embodiment of the invention is provided with a wire unit 12 that is formed by combining a plurality of unit electric wires 11 that are insulated from each other and that run electrically parallel to each other into a one wire. The wire unit 12 is formed by braiding a plurality of unit electric wires 11. Each unit electric wire 11 is a conductor. Also, in FIG. 1 and FIG. 2, the construction of insulating each of the unit electric wires 11 from each other is shown in detail, however, insulating between each of the unit electric wires 11 can be performed by forming insulation around the outside of each individual unit electric wire 11, or by placing each of the unit electric wires 11 such that they are separated from each other, and then bonding and securing between unit electric wires 11 with an insulating material. It is possible to use either construction.

By winding this wire unit 12, which is provided with a plurality of unit electric wires 11 that are integrated together, around the voice-coil bobbin, it is capable of functioning as a voice coil. When current flows in the wire unit 12, the current flows in parallel in the plurality of unit electric wires 11.

With a voice coil 10 having this kind of construction, since a plurality of unit electric wires 11 that are insulated from each other are combined into one wire, it is possible to increase the current-carrying capacity of the wire unit 12 while maintaining or without greatly increasing the overall diameter d1 of the wire unit 12. In other words, even though due to surface effects, the current flows only near the surface of each of the unit electric wires 11, since there are a plurality of unit electric wires 11 in the wire unit 12, looking at the wire unit 12 as a whole, the area through which current is flowing is large. Therefore, it is possible to increase the current-carrying capacity while maintaining the diameter d1 of the wire unit 12. Moreover, it is possible to decrease the diameter d1 of the wire unit 12 while maintaining the current-carrying capacity. For example, when comparing the current-carrying capacity of a wire unit 12 having a diameter d1 and formed by combining a plurality of unit electric wires 11 each having a comparatively small diameter into one wire, with that of a wire unit having a diameter d1 and made from a single electric wire, the current-carrying capacity of the wire unit 12 is larger.

With this voice coil 10, since it is possible to increase the current-carrying capacity, it is possible to improve the input characteristics, sound quality and frequency characteristics, or heat resistance of a speaker that uses the voice coil 10. Also, since it is possible to maintain or decrease the diameter d1 of the wire unit 12 while keeping sufficient current-carrying capacity, it is possible to maintain or reduce the weight of the voice coil. Moreover, it is possible to maintain or reduce the overall thickness of the voice coil 10 when the wire unit 12 is wound around the bobbin (cross-sectional thickness of the layered wire unit 12).

In FIG. 1 and FIG. 2, the wire unit 12 is formed by combining a plurality of unit electric wires 11 into one wire. In this construction, Litz wire could also be used as the wire unit 12. Also, the construction of combining a plurality of unit electric wires 11 into one wire is not limited to this. For example, the wire unit could be formed by weaving a plurality of unit electric wires together. Also, the wire unit could be formed by twisting a plurality of unit electric wires together. Furthermore, the wire unit could be formed by bundling a plurality of unit electric wires together.

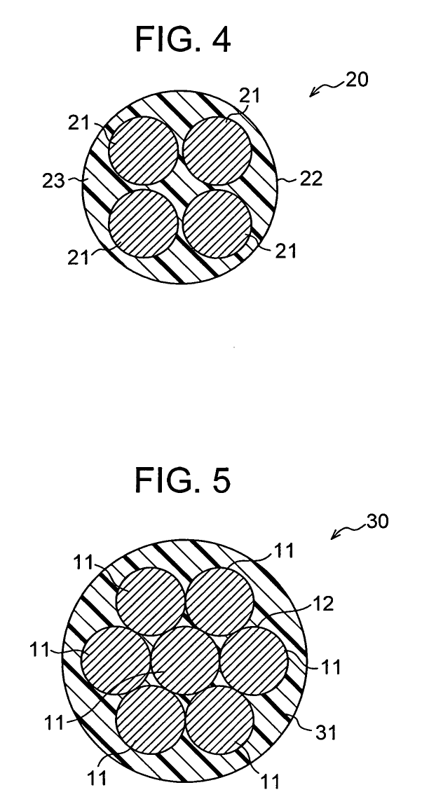

Also, it is possible to form the wire unit by integrating a plurality of unit electric wires using a bonding material. FIG. 3 and FIG. 4 show this embodiment. In other words, FIG. 3 is a side view of a voice coil of a second embodiment of the invention, and FIG. 4 is an enlarged cross-sectional view of a cross section taken across the diameter of the voice coil shown in FIG. 3. The voice coil 20 shown in FIG. 3 and FIG. 4 is provided with a wire unit 22 that is formed by combining a plurality of unit electric wires 21 that are insulated from each other and that run electrically parallel with each other to form one wire. The wire unit 22 is formed by neither braiding, weaving nor twisting the plurality of unit electric wires 21 together, but by placing them such they run parallel to each other and are separated from each other, and bonding each of the unit electric wires 21 together with a bonding material 23. It is possible to use a polyamide-type plastic or epoxy-type plastic as the bonding material 23, however it is not limited to these. A bonding material is used for combining the plurality of unit electric wires 21 instead of braiding, weaving, or twisting them together, however another method could also be used. For example, all of the unit electric wires 21 could be covered by placing them together in an insulated tube.

On the other hand, it is also possible to form a bonding layer around the wire unit of the voice coil. FIG. 5 shows this embodiment. In other words, FIG. 5 is a side view showing the voice coil of a third embodiment of the invention. The voice coil 30 shown in FIG. 5 is provided with a wire unit 12 that is formed by combining a plurality of unit electric wires 11 that are insulated from each other and that run electrically parallel to each other or form one wire as in the case of the voice coil 10 in the first embodiment. Also, a bonding layer 31 is formed around the outside of the wire unit 12. This wire unit 12 having a bonding material 31 formed around the outside in this way is wound around the bobbin while applying methanol or the like, and then by applying heat, the bonding layer is thermally hardened, and it is possible to firmly fasten the wire unit 12 to the bobbin.

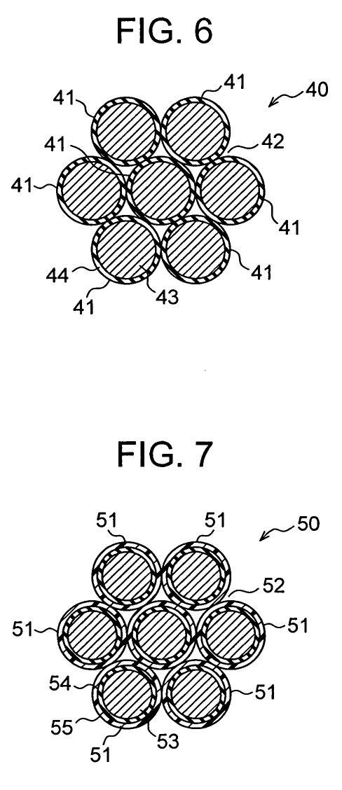

In FIG. 1 to FIG. 5, the construction of each individual unit electric wire is not shown in detail. Therefore, here the construction of the unit electric wire will be explained in detail. FIG. 6 is an enlarged cross-sectional drawing showing a cross section across the diameter of the voice coil of a fourth embodiment of the invention. As shown in FIG. 6, the voice coil 40 is provided with a wire unit 42 that is formed by combining a plurality of unit electric wires 41 together such that they run electrically parallel with each other to for one wire, and each of the unit electric wires 41 is provided with a conducting wire 43 and an insulation layer 44 that is formed around the outside of the conducting wire 43, such that each of the unit electric wires 41 are insulated from each other by the insulation layers 44. It is possible to use copper, nickel, aluminum or the like as the material for the conducting wire 43, and it is possible to use an insulating material such as polyester, polyesterimide, amide-imide, polyimide or the like as the material of the insulation layer 44, however the materials are not limited to these.

Also, it is possible to form an insulation layer around the outside of the conductive material, and to further form a bonding layer around that. FIG. 7 shows that embodiment. In other words, FIG. 7 is an enlarged cross-sectional drawing showing a cross section across the diameter of the voice coil of a fifth embodiment of the invention. The voice coil 50 shown in FIG. 7 is provided with a wire unit 52 that is formed by combining a plurality of unit electric wires 51 such that they run electrically parallel with each other to form one wire, and each of the unit electric wires 51 comprise a conducting wire 53, an insulation layer 54 that is formed around the outside of the conducting wire 53, and a bonding layer 55 that is formed around the outside of the insulation layer 54. The unit electric wires 51 are insulated from each other by the insulation layers 54. Also, the unit electric wires 51 are bonded and secured together by the bonding layers 55. For example, by applying heat to the bonding layers 55, the bonding layers 55 are melted, and then when they harden after that, the unit electric wires 51 are bonded and secured together by the bonding layers 55. Moreover, by increasing the viscosity of the surface of the bonding layers 55 by applying a solvent to the bonding layers 55, it is possible to bond (temporarily bond) the plurality of unit electric wires 51 together. This makes manufacturing of the wire unit 12 easier.

In FIG. 1 to FIG. 7, examples were given of forming the wire unit using four or seven unit electric wires, however, the number of unit electric wires used for forming the wire unit is not limited to these. The number of unit electric wires of the wire unit can be any number two or more. For example, the wire unit can be formed by twisting together two unit electric wires. However, in the case of braiding or weaving the unit electric wires, three or more unit electric wires are necessary. In this case, the wire unit is formed using three or more unit electric wires.

Also, in the voice coils shown in FIG. 1 to FIG. 7, the plurality of unit electric wires are combined into one wire such that the outer shape of a cross section taken across the diameter of the wire unit has a top-bottom symmetrical shape or left-right symmetrical shape. The voice coil of this invention does not have to be formed such that the plurality of unit electric wires are combined into one wire where the outer shape of a cross section taken across the diameter of the wire unit has a top-bottom symmetrical shape or left-right symmetrical shape. However, by combining the plurality of unit electric wires such that the outer shape of a cross section taken across the diameter of the wire unit has a top-bottom symmetrical shape or left-right symmetrical shape, it is easier to wind the wire unit when winding it onto the bobbin, and it is possible to layer the wire uniformly, as well as it is possible to increase the tightness or closeness of the wound wire unit or to increase the number of windings.

### EXAMPLES

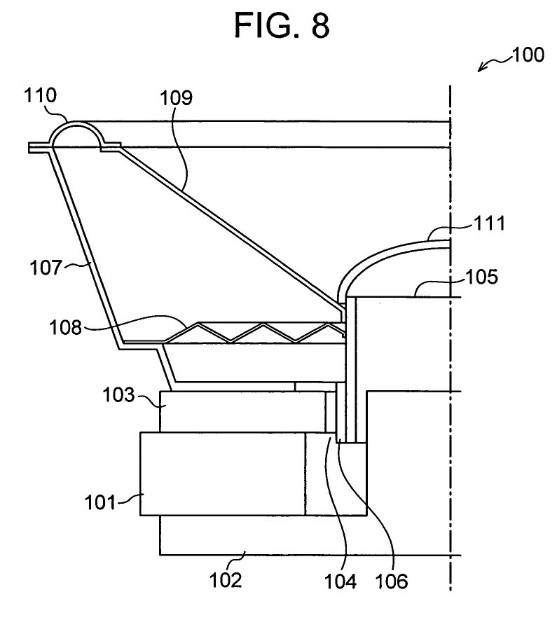

Next, examples of this invention are explained based on FIG. 8 to FIG. 12. In the examples below, the voice coil of this invention is applied to the voice coil of a speaker.

FIG. 8 is a vertical cross-sectional view of a speaker containing the voice coil of an embodiment of the invention (only the left half is shown). As shown in FIG. 8, the speaker 100 is provided with a magnetic circuit having a ring-shaped magnet 101 that is held between a yoke 102 and plate 103. The voice coil 106 is wound into a circular shape around the coil bobbin 105 such that is coaxial with the bobbin 105, and it is inserted into the magnetic space that is formed between the yoke 102 and plate 103. Moreover, a frame 107 is fastened to the plate 103, and there is a damper 108 located between the frame 107 and the voice-coil bobbin 105. The tip end of the voice-coil bobbin 105 is fastened to the diaphragm 109, and the outer edge of the diaphragm 109 is connected to the outer edge of the frame 107 by way of the speaker edge 110. Also, a dust cap is attached to the tip end of the voice-coil bobbin 105.

When an electrical signal is input to the voice coil 106, the voice-coil bobbin 105 and the diaphragm 109 vibrate by the magnetic flux facing in the radial direction of the magnetic space 104 and the concentric circular-shaped current that flows in the voice coil 106, and this converts the electrical signal to sound.

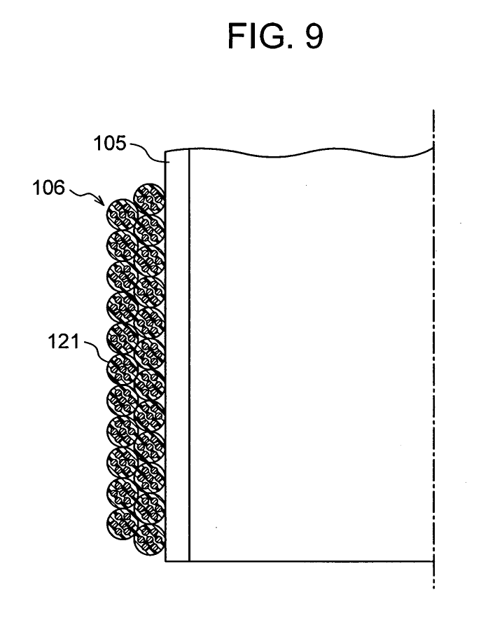

FIG. 9 is an enlarged cross-sectional view of the voice-coil bobbin 105 and voice coil 106 contained in the speaker 100 shown in FIG. 8 (only the left half is shown). As shown in FIG. 9, the voice coil 106 is formed by winding the wire unit 121 around the outside of the voice-coil bobbin 105.

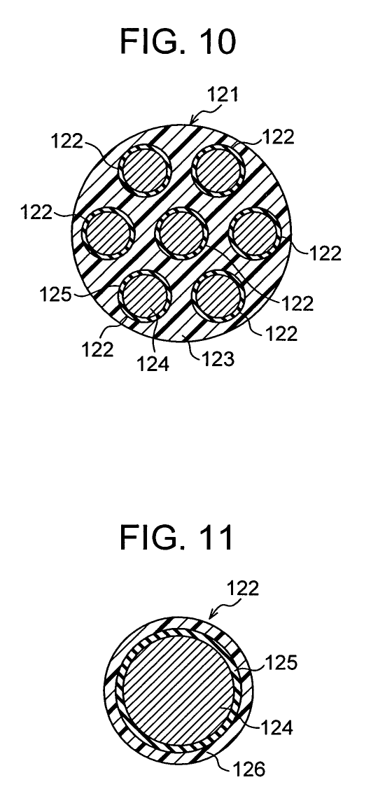

FIG. 10 is an enlarged cross-sectional view of the wire unit 121 of the voice coil 106 shown in FIG. 9. As shown in FIG. 10, the wire unit 121 of the voice coil 106 is formed by combining seven unit electric wires 122 such that they are insulated from each other and run electrically parallel with each other to form one wire. The unit electric wires 122 are extended nearly parallel to each other without being twisted together. Also, the unit electric wires 122 are combined together into one wire such that the cross section taken across the diameter of the wire unit 121 has a top-bottom symmetrical shape or left-right symmetrical shape. In this example, construction was used in which the unit electric wires 122 are not twisted together, however, construction in which the unit electric wires 122 are braided, woven or twisted together is also possible.

The unit electric wires 122 are bonded and integrated together using a bonding material 123. This bonding material 123 is formed such that it covers the unit electric wires 122 and bundles the unit electric wires together, and also forms the outer surface of the wire unit.

Each individual unit electric wire 122 is provided with a conductive wire 124, and insulation layer 125 that is formed around the outside of the conductive wire 124.

The electric signal flows through each of the unit electric wires 122 of the voice coil 106 in order to vibrate the diaphragm 109 and generate sound. Therefore, both ends of each unit electric wire 122 are connected to a circuit for supplying this electric signal. The unit electric wires 122 are connected to the circuit such that they are electrically parallel with each other, and the electrical signal is supplied simultaneously to each unit electric wire 122.

FIG. 11 is a cross-sectional view showing the wire unit 121 used as the raw material for the voice coil 106 or wire unit 121 before being made into the voice coil 106 or wire unit 121. In the step before making the voice coil 106 or wire unit 121, the insulation layer 125 of the unit electric wire 122 is covered with a bonding layer 126. When making the voice coil 106 or wire unit 121, the necessary number of unit electric wires 122 for forming the wire unit 121 are brought close together such that they are separated by a specified distance, brought in contact with each other, braided together, woven together or twisted together and then heated, and after the bonding layer 126 around each unit electric wire 122 melts it is let to harden. In this way the bonding layers 126 around each of the unit electric wires 122 become the bonding material 123 shown in FIG. 10, and the unit electric wires 122 are bonded and integrated together by this bonding material 123. This bonding and integration manufacturing process can be performed before the step of winding the wire unit 121 around the voice-coil bobbin 105, or can be performed after the step of winding the wire unit 121 around the voice-coil bobbin 105.

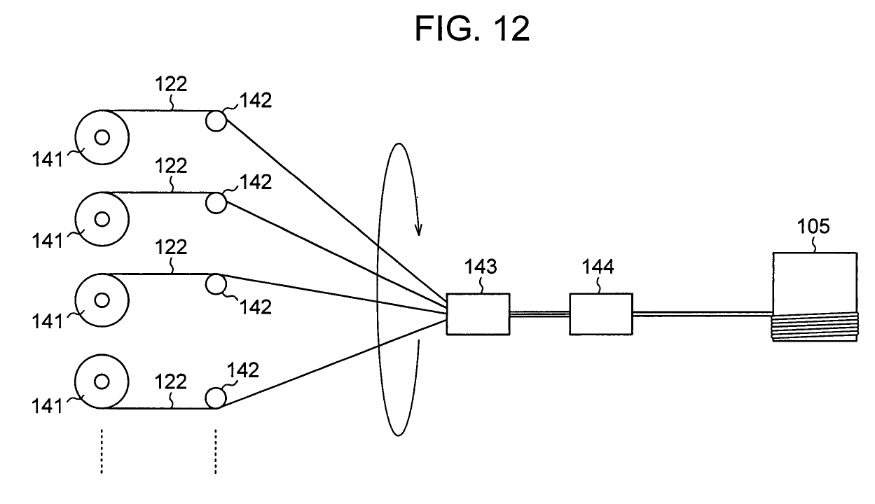

FIG. 12 shows an example of the manufacturing method for the voice coil 106. As shown in FIG. 12, in order to manufacture the voice coil 106, first, the unit electric wires 122 that are covered with a bonding layer 126 as shown in FIG. 11 are prepared. Next, the unit electric wire 122 is wound around feed bobbins 141 equal to the number of unit electric wires of the wire unit 121, or seven wires in this embodiment (only four are shown in the figure), and the unit electric wire 122 is fed from these feed bobbins 141 via rollers 142. These seven unit electric wires 122 are then inserted into the bundling inlet 143, and the bundling inlet 143 positions these unit electric wires 122 such that they come in contact with each other. Next, the unit electric wires 122 that are in contact with each other are fed to the solvent-application unit 144, and the solvent-application unit 144 applies solvent (for example methanol) and temporarily bonds (semi-bond) these unit electric wires 122 together. Next, the temporarily bonded unit electric wires 122 are wound around the voice-coil bobbin 105 by an auto-winding machine. Then, the unit electric wires 122 that are wound around the voice-coil bobbin 105 are heated together with the voice-coil bobbin 105 to approximately 200° C., to harden the bonding layer 126 covering each of the unit electric wires 122. After that, the unit electric wires 122 that are wound around the voice-coil bobbin 105 are let to sit at room temperature together with the voice-coil bobbin 105 until they become stable. The voice coil 106 is formed in this way. The manufacturing method explained above is a manufacturing method for a voice coil 106 in which the plurality of unit electric wires 122 are run in parallel without being twisted with each other. In the case of manufacturing a voice coil in which the plurality of unit electric wires are braided or twisted together, an apparatus that is provided with feed bobbins 144 and rollers 142 can be turned in the direction of the arrow shown in FIG. 12. Also, it is possible to perform turning on the side of the voice-coil bobbin 105.

As was described in detail above, with the voice coil 106 of the embodiments of this invention, a plurality of insulated unit electric wires 122 are combined together to more a wire unit 121, so it is possible to increase the current-carrying capacity of the wire unit 121 while maintaining or without greatly increasing the overall diameter of the wire unit 121. Also, it is possible to reduce the diameter of the wire unit 121 while maintaining the current-carrying capacity. Therefore, it is possible to improve the input characteristics, sound quality and frequency characteristics, or heat resistance of a speaker 100 that uses the voice coil 106. Moreover, since it is possible to maintain or reduce the diameter of the wire unit 121 while keeping sufficient current-carrying capacity, it is possible to maintain or reduce the weight of the voice coil 106. Also, it is possible to maintain or reduce the overall thickness of the coil (or in other words, thickness of a cross section of the layered wire unit 121) when the voice coil is wound around the bobbin.

This invention can be adequately modified within a range that will not affect the substance and concept of the invention that can be read from the claims and description of the invention, and the voice coil according to those changes and speaker that uses it are also included in the technical concept of this invention.

The entire disclosure of Japanese Patent Application No. 2003-003226 filed on Jan. 9, 2003 including the specification, claims, drawings and summary is incorporated herein by reference in its entirety.

What is claimed is:

1. A voice coil comprising:
a wire unit, which is formed by combining a plurality of unit electric wires and the unit electric wires are electrically parallel with each other to form one voice coil; and
an insulation member for insulating the unit electric wires each other.

2. The voice coil according to claim 1, wherein the wire unit is formed by braiding the plurality of unit electric wires together.

3. The voice coil according to claim 1, wherein the wire unit is formed by weaving the plurality of unit electric wires together.

4. The voice coil according to claim 1, wherein the wire unit is formed by twisting the plurality of unit electric wires together.

5. The voice coil according to claim 1, wherein the wire unit is formed by bundling the plurality of unit electric wires.

6. The voice coil according to claim 1, further comprising:
a bonding material for bonding the plurality of unit electric wires to be integrated.

7. The voice coil according to claim 1, wherein the wire unit is Litz wire.

8. The voice coil according to claim 1, further comprising: a bonding layer that is formed around the outside of the wire unit.

9. The voice coil according to claim 1, wherein the wire unit comprises two or more unit electric wires.

10. The voice coil according to claim 1, wherein the plurality of unit electric wires each comprise a conductive wire and an insulation layer that is formed around the outside of the conductive wire.

11. The voice coil according to claim 1, wherein said plurality of unit electric wires are each covered by a bonding layer.

12. The voice coil according to claim 1, wherein the plurality of unit electric wires are combined together such that the outer shape of a cross section taken across the diameter of the wire unit has a top-bottom symmetrical shape or left-right symmetrical shape.

13. A manufacturing method for the voice coil bobbin comprising:
a covering process of covering unit electric wires with a bonding layer;
a first winding process of winding unit electric wire around feed bobbins which is equal to the number of unit electric wires;
a first feeding process of feeding unit electric wires from the feed bobbins;
an inserting process of inserting unit electric wires into the bundling inlet, which positions these unit electric wires such that they come in contact with each other;
a second feeding process of feeding the unit electric wires which are in contact with each other to the solvent-application unit;
an applying process of applying the solvent-application unit solvent and bonding the unit electric wires together;
a second winding process of winding bonded unit electric wires around the voice-coil bobbin by an auto-winding machine; and
a heating process of heating the unit electric wires wound around the voice-coil bobbin together with the voice-coil bobbin.

14. A speaker comprising:
a wire unit, which is formed by combining a plurality of unit electric wires and the unit electric wires are electrically parallel with each other to form one voice coil;
an insulation member for insulating the unit electric wires each other;
a bonding layer that is formed around the outside of the unit electric wire;
a bobbin for being wound by the unit electric wires;
a vibration plate for being vibrated by the bobbin;
a magnet for surrounding the bobbin;
a yoke for being substantially connected to the magnet;
a plate for being substantially connected to the magnet; and
a damper for being connected to the bobbin.
